(19) United States
(12) Patent Application Publication
(10) Pub. No.: US 2013/0293347 A1
(43) Pub. Date: Nov. 7, 2013

(54) KEYLESS VEHICLE ENTRY DEVICE

(71) Applicant: William Barnes, Reisterstown, MD (US)

(72) Inventor: William Barnes, Reisterstown, MD (US)

(21) Appl. No.: 13/461,613

(22) Filed: May 1, 2012

(51) Int. Cl. G06F 7/04

(52) U.S. Cl. 340/5.53

(57) ABSTRACT

The present invention is a keyless vehicle entry device that includes an oval shaped fingerprint scanning actuator to scan a user's fingerprint and includes a power button to actuate the fingerprint scanning actuator and a plastic CPU and memory system that processes and stores up to 3 fingerprints that reside on the CPU and memory system. The fingerprint scanning actuator compares and confirms the user's fingerprint with the fingerprints that reside on the CPU and memory system and unlocks a locked door of a protected vehicle utilizing the keyless vehicle entry device.

### TECHNICAL FIELD & BACKGROUND

Many cars require a set of keys or a key fob to unlock a vehicle door, which allows anyone with access to the set of keys or the key fob with a way to enter the vehicle. If a person accidentally locks their keys in their car, it can be expensive and time consuming to wait for a locksmith to enter the vehicle.

The present invention generally relates to a vehicle entry device. More specifically, the invention is a keyless vehicle entry device.

It is an object of the invention to provide a keyless vehicle entry device that unlocks a locked car door with a scanned fingerprint.

It is an object of the invention to provide a keyless vehicle entry device that utilizes a computerized system to unlock a locked car door.

It is an object of the invention to provide a keyless vehicle entry device that is powered by a vehicle's battery.

What is really needed is a keyless vehicle entry device that unlocks a locked car door with a scanned fingerprint that utilizes a computerized system to unlock a locked car door that is powered by a vehicle's battery.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a keyless vehicle entry device, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

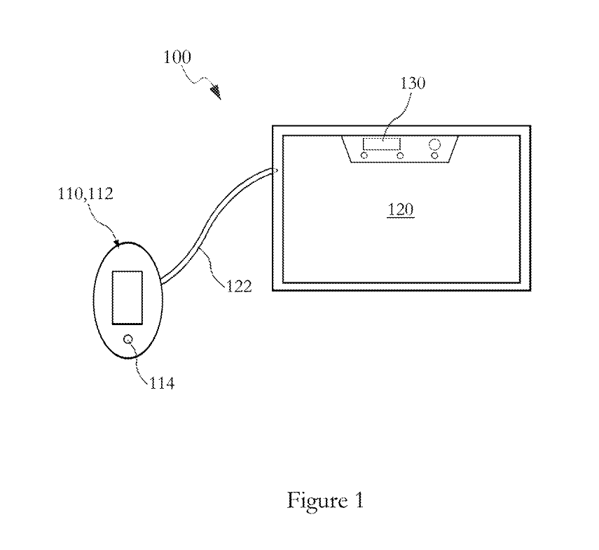

FIG. 1 illustrates a front view of a keyless vehicle entry device 100, according to an embodiment of the present invention.

The keyless vehicle entry device 100 includes a fingerprint scanning actuator 110 and a CPU and memory system 120. The fingerprint scanning actuator 110 is oval shaped 112 but can be any suitable shape to scan a user's finger print and includes a power button 114 to actuate the fingerprint scanning actuator 110. The CPU and memory system 120 processes and stores a plurality of finger prints that reside on the CPU and memory system 120. The CPU and memory system 120 can store up to 3 fingerprints and is made of plastic or any other suitable material. The fingerprint scanning actuator 110 is also in communication with the CPU and memory system 120 with a wire 122 or other suitable communication device including any suitable wireless communication system (not shown). The keyless vehicle entry device 100 also recognizes up to 3 fingerprints that reside on the CPU and memory system 120 that can be utilized to enter a vehicle utilizing the keyless vehicle entry device 100. A user would simply enter their fingerprints on the CPU and memory system 120 and place their finger on the oval shaped 112 fingerprint scanning actuator 110 that compares and confirms the user's fingerprint with the fingerprints that reside on the CPU and memory system 120 and unlock a lock door of a protected vehicle utilizing the keyless vehicle entry device 100. The keyless vehicle entry device 100 is powered by the vehicle's battery 130, although other suitable power sources can be utilized to power the keyless vehicle entry device 100.

The keyless vehicle entry device is an automotive security system. The keyless vehicle entry device scans and stores up to three fingerprints. Measuring approximately 1.5 inches in length with an oval shaped actuator, the keyless vehicle entry device is connected to an approximate 4 inches in width by 3 inches in height CPU and is made of plastic. To use the car battery operated keyless vehicle entry device, a user simply presses the power button, places a finger on the scanner and unlocks the vehicle. Car owners are among the many people who may find the keyless vehicle entry device both convenient and easy to use. The keyless vehicle entry device features a fingerprint scanner and storage unit to unlock the door of an automobile or other suitable vehicle. The keyless vehicle entry device is designed to provide access to a vehicle without the use of a key.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A keyless vehicle entry device, comprising:
a fingerprint scanning actuator to scan a user's finger print and includes a power button to actuate said fingerprint scanning actuator; and
a CPU and memory system that processes and stores a plurality of finger prints that reside on said CPU and memory system.

2. The keyless vehicle entry device according to claim 1, wherein said fingerprint scanning actuator is oval shaped.

3. The keyless vehicle entry device according to claim 1, wherein said fingerprint scanning actuator is in communication with said CPU and memory system with a wire.

4. The keyless vehicle entry device according to claim 1, wherein said fingerprint scanning actuator compares and confirms said user's fingerprint with said fingerprints that reside on said CPU and memory system and unlock a locked door of a protected vehicle utilizing said keyless vehicle entry device.

5. The keyless vehicle entry device according to claim 1, wherein said user enters said fingerprints on said CPU and memory system and places a finger on said oval shaped fingerprint scanning actuator.

6. The keyless vehicle entry device according to claim 1, wherein said CPU and memory system can store up to 3 fingerprints.

7. The keyless vehicle entry device according to claim 6, wherein said keyless vehicle entry device recognizes up to 3 said fingerprints that reside on said CPU and memory system.

8. The keyless vehicle entry device according to claim 6, wherein said fingerprints can be utilized to enter said vehicle utilizing said keyless vehicle entry device.

9. The keyless vehicle entry device according to claim 1, wherein said CPU and memory system is made of plastic.

10. The keyless vehicle entry device according to claim 1, wherein said keyless vehicle entry device is powered by said vehicle's battery.

11. A keyless vehicle entry device, comprising:
a fingerprint scanning actuator to scan a user's fingerprint and includes a power button to actuate said fingerprint scanning actuator; and
a plastic CPU and memory system that processes and stores up to 3 fingerprints that reside on said CPU and memory system.

12. The keyless vehicle entry device according to claim 11, wherein said fingerprint scanning actuator is oval shaped.

13. The keyless vehicle entry device according to claim 11, wherein said fingerprint scanning actuator is in communication with said CPU and memory system with a wire.

14. The keyless vehicle entry device according to claim 11, wherein said fingerprint scanning actuator compares and confirms said user's fingerprint with said fingerprints that reside on said CPU and memory system and unlocks a locked door of a protected vehicle utilizing said keyless vehicle entry device.

15. The keyless vehicle entry device according to claim 11, wherein said user simply presses said power button, places a finger on the scanner and unlocks said vehicle.

16. The keyless vehicle entry device according to claim 15, wherein said user enters said fingerprints on said CPU and memory system and places said finger on said oval shaped fingerprint scanning actuator.

17. The keyless vehicle entry device according to claim 16, wherein said keyless vehicle entry device recognizes up to 3 said fingerprints that reside on said CPU and memory system.

18. The keyless vehicle entry device according to claim 16, wherein said fingerprints can be utilized to enter said vehicle utilizing said keyless vehicle entry device.

19. The keyless vehicle entry device according to claim 11, wherein said keyless vehicle entry device is powered by said vehicle's battery.

20. The keyless vehicle entry device according to claim 11, wherein said keyless vehicle entry device is connected to an approximate 4 inches in width by 3 inches in height CPU.
